(19) United States
(12) Patent Application Publication
(10) Pub. No.: US 2026/0080341 A1
(43) Pub. Date: Mar. 19, 2026

(54) SYSTEM AND METHOD FOR EVALUATING AND SCORING INDIVIDUALS AND ENTITIES AND DISPLAYING THE SCORE OF EACH RESPECTIVE INDIVIDUAL OR ENTITY

(71) Applicant: John Paul MORAN, Billerica, MA (US)

(72) Inventor: John Paul MORAN, Billerica, MA (US)

(21) Appl. No.: 19/108,340

(22) PCT Filed: Sep. 5, 2023
(86) PCT No.: PCT/US2023/073475

§ 371 Date: Mar. 3, 2025

(51) Int. Cl. G06Q 10/0639; G06Q 50/26

(52) U.S. Cl. CPC G06Q 10/0639; G06Q 50/26

(57) ABSTRACT

Aggregation and scoring system for collecting and analyzing public and survey data of public entities, private entities, elected officials, candidates for public office, and other individuals or entities who hold a position of public or private prominence, or public or private influence, to generate a five-tiered score predicated on predetermined metrics of evaluation.

### FIELD

This invention is directed to automatic and digital public information evaluation of individuals and/or entities. More particularly, it is directed to providing a platform and method for an agnostic evaluation of individuals and organizations based on publicly available information and providing a “scoring” as compared to relevant issues, such as political interests or financial interests, etc.

### BACKGROUND

The tools the public has at their disposal with respect to an objective and consistent analysis of policies and performances of public entities, private entities, elected officials, candidates for public office, and other individuals or entities who hold a position of public or private prominence, or public or private influence is nonexistent. The tools that are available are often partisan or biased and serve the interests of entities generating the rating. The organizations that advertise their ratings to their members and to the public, do so as an attempt to shape voter preferences and advocate for the individuals or entities most closely aligned with their political interests or financial interests. [Ref. 1]

One study estimated that by the time Ronald Reagan (R) ran for a second term in 1984, over 90 organizations were actively rating members of Congress and other politicians in the United States, all with their own agendas and their own methodologies tailored for their respective individual agendas. [Ref. 1] The vast majority of these rating systems are partisan, politically motivated, and opaque with respect to their methodology. Other sites, such as Ballotpedia simply present publicly available data such as voting record and polling result without further analysis or rating method, leaving the user to sift through all the data. [Ref. 2]

Either model leaves possibilities of user error and overreliance that results in the user being misinformed as to the data, misled as to the data, or frustrated due to the vast amount of information they must sift through just to draw a rudimentary conclusion as to the candidate's competency. [Ref. 3]

Therefore, traditional methods of user presentation are prone to leave an information seeker without the concise evaluation they sought. The information overload may discourage further candidate research and may lead to a population of less informed voters due to the frustration associated with seeking out candidate data. [Ref. 4]

Another problem with many of the current methods of rating and evaluation is the basis on which the scores are derived, as many display a propensity to exacerbate partisan bias. Many of the current ratings currently available predicate their scores on arbitrary and unrepresentative metrics such as a voting record on a singles issue, general popularity, unreliable polling data, and other unreliable parameters. [Ref. 5]

Thus, it would be desirable to provide a more objective and streamlined method for collecting and analyzing data from public information and survey collection. It would also be desirable to analyze this data in such a way that candidate rating is transparent, objective, and applied evenly across all political affiliations. When presenting easily abused evaluation metrics to the public, it is of the utmost importance that the methodology and sources for which the conclusion was reached, be available so users can assess the veracity of the score and the credibility of the data that allowed for the generation of that score. [Ref. 6]

### SUMMARY

Descriptions are provided for aggregating and analyzing data from publicly available information and electronically transmitted surveys and their electronically transmitted responses via webpages for the purpose of generating a score or rating to inform interested parties as to the competency of the official, candidate, individual or entity as determined by a five-tier rating system. The system includes a database which stores aggregated public information and survey data provided by the officials, representatives or candidates, themselves. A module sends an electronic communication to the official, candidate, individual, spokesperson, officer, or otherwise, preferably via email, requesting them to complete the survey and submit their responses. The responses are returned to the sender preferably via electron transmission through email or the submission of a webform. The electronic communication is preferably containing an embedded survey or a link to a survey on a webpage, where the link takes the official, candidate, individual, spokesperson, officer, or otherwise, to a webpage with the predetermined survey questions through which the official, candidates, individual, spokesperson, officer, or otherwise, can input their responses to the survey and electronically submit the form. If the survey is embedded in the email, the official, candidate, individual, spokesperson, officer, or otherwise, fills out the survey via the embed and returns the form to sender. The score of the individual or the entity is displayed using representative figural graphics that enable the viewer to access an overview of the individual or entity. This allows users to have a comprehensive assessment of the performance of the individual or entity without the need to compile the information from individual searches and without a consistent of method of evaluating individuals or entities that uses identical parameters for a parallel and consistent evaluation. [Ref. 7]

For example in various embodiments, aspects of an automatic scoring system for aggregating and analyzing digital data from publicly available information of an individual to determine a competency of the individual is provided, comprising, a database containing aggregated public information concerning an individual; and an evaluation module, reading the aggregated public information and generating at least one of a score and rating of the individual in respect to a predetermined topic, wherein the at least one score and rating is viewable by another individual. [Ref. 8]

In other various embodiments, aspects of the above system is provided and/or, wherein the individual is a representative of an organization or political party and/or wherein the individual is at least one of a business candidate and public office candidate; and/or the individual is at least one of a business official and a public office official; and/or wherein the database contains survey information concerning the individual; and/or wherein the survey information is obtained from a survey at least one of sent to the individual and received by the evaluation module; and/or wherein the at least one score and rating is a multi-tiered score, each tier is graded through a numeric and pictographic representation of a variably tiered score, wherein the evaluation module evaluates at least one of position consistency, legislative history, substantive policy stances and categoric public interest commitment of the individual; and/or wherein the evaluation module evaluates at least one of personal opportunity, economic opportunity, social opportunity, educational opportunity and national opportunity of the individual; and/or wherein the evaluation module further comprises: a data cleaner module; a categorization module; an analysis module; a score aggregation module; and an individual profile uploading module; and/or wherein questions of the survey information are modifiable according to a desired metric of evaluation; and/or wherein the least one of score and rating is based on a number of tiers (n), the individual having a total of n+1 scores, wherein an additive score is an aggregate mean score; and/or further comprising an aggregate score value which is a derivative of scores generated in tiered categories. [Ref. 9]

In other embodiments, aspects of a method of aggregating and analyzing digital data from publicly available information of a person or entity to determine a competency of the target person or entity is provided, comprising: a computerized system running an evaluation software module, performing steps comprising: polling a database for aggregated public information concerning the person or entity; reading the aggregated public information; generating at least one of a score and rating of the person or entity in respect to a predetermined topic based on the read information; and displaying the at least one score and rating to another individual. [Ref. 10]

In yet other embodiments, aspects of the above method is provided, wherein the person or entity is representative of a private or public organization; and/or, further comprising sending a survey to the person or entity to obtain a response; and/or wherein the database contains survey information concerning the person or entity; and/or further comprising evaluating at least one of position consistency, legislative history, substantive policy stances and categoric public interest commitment of the person or entity; and/or further comprising evaluating at least one of personal opportunity, economic opportunity, social opportunity, educational opportunity and national opportunity of the person or entity; and/or wherein the at least one score and rating is a multi-tiered score, each tier being graded through at least one of a numeric and pictographic representation of a variably tiered score; and/or wherein the steps further comprise: developing survey questions: selecting the person or entity to be surveyed; administering the survey questions via a webpage or embedded link; receiving a survey response from the person or entity; allocating the survey response to a profile of the person or entity; and inputting results of the survey response into the generating step; and/or further comprising combining survey data and organized web data; inputting the combined data to a variably tiered score analytic evaluation module; and outputting a figural representation of an output of the variably tiered score analytic evaluation module. [Ref. 11]

### BRIEF DESCRIPTION

This application will become more fully understood from the following detailed description, taken in conjunction with the accompanying figures, wherein like reference numerals refer to like elements in which:

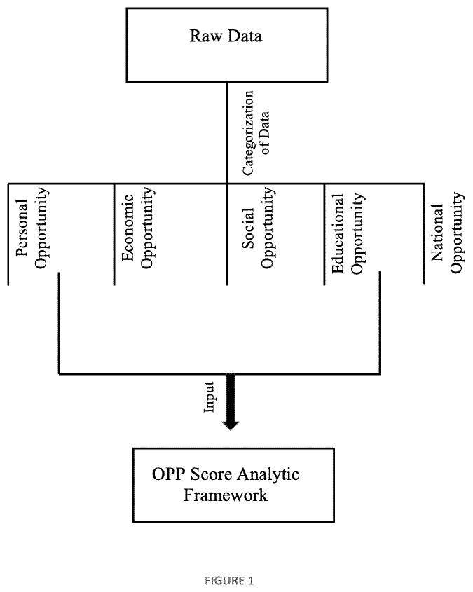

FIG. 1 is a block and line diagram representing the data lifecycle in the OPP Score analytic framework.

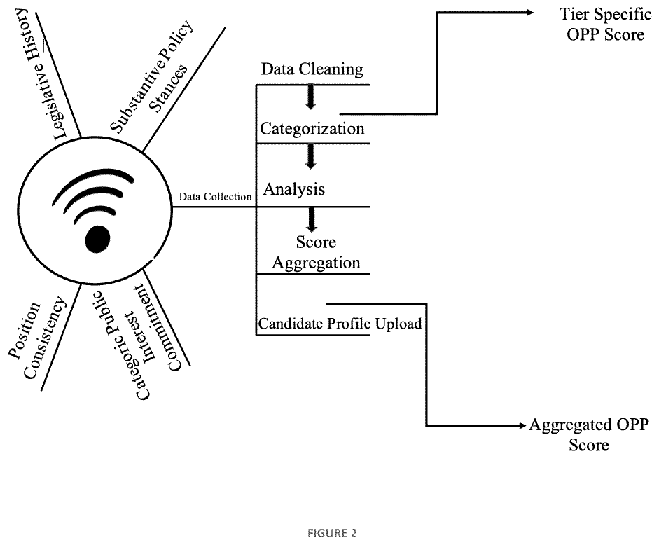

FIG. 2 represents the data metrics of consideration in evaluating the performance of an official, candidate, individual, spokesperson, officer, and how that data is then analyzed and stored.

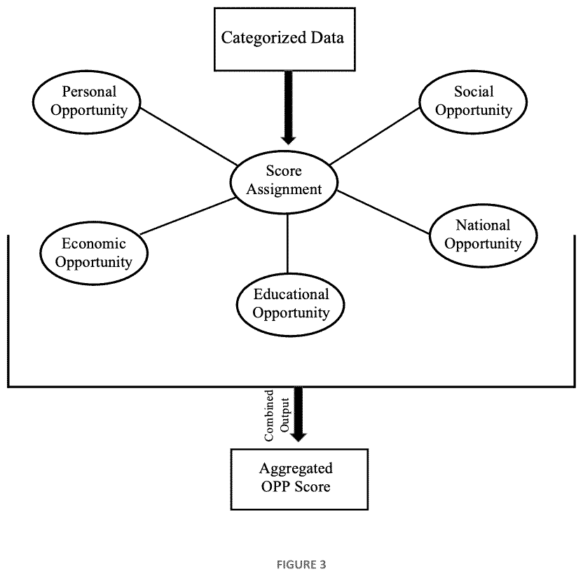

FIG. 3 is a circle and line diagram displaying possible tier categorizations for data organization. After the data organization the respective tier data is utilized in the OPP score analytic framework, and then those generated scores are utilized in the calculation of the aggregate OPP score, representing the overall performance of the official, candidates, individual, spokesperson, officer, or otherwise.

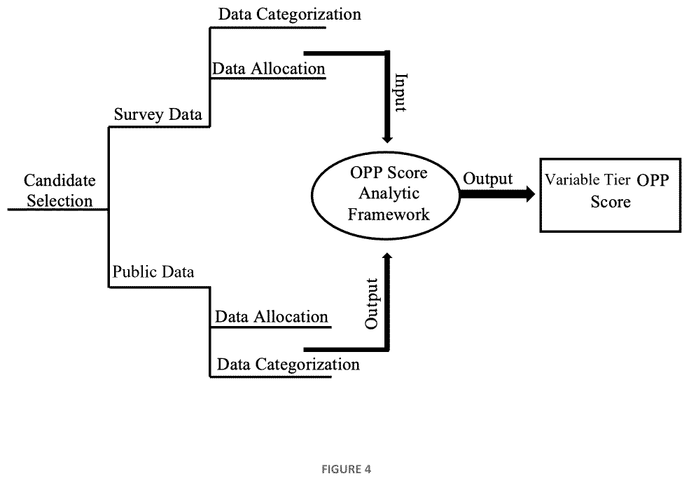

FIG. 4 represents the two types of data utilized to assess an official, candidate, individual, spokesperson, officer, or otherwise after selection, and how that data is jointly utilized in calculating the individual tier scores, and the aggregate score thereafter.

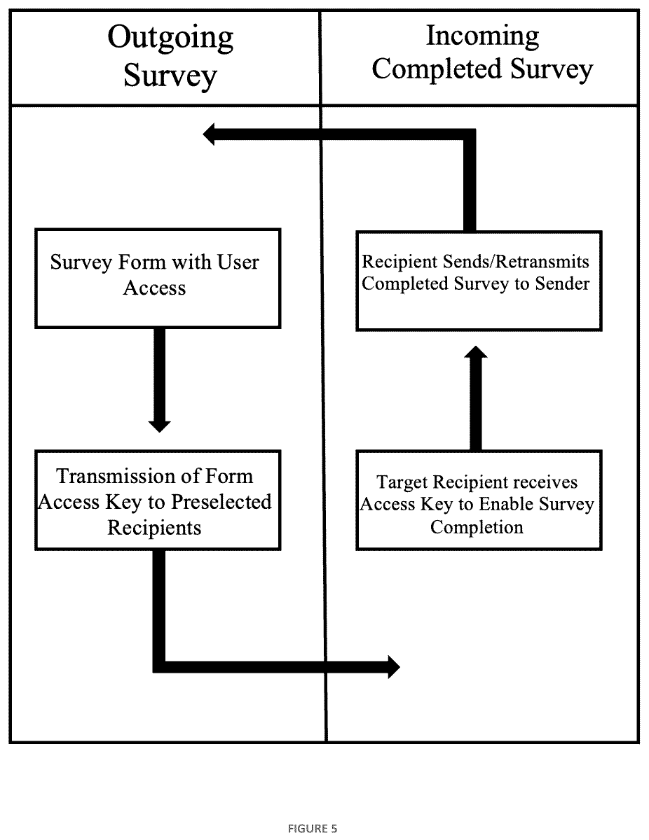

FIG. 5 represents the survey collection process and method of transmission and storage.

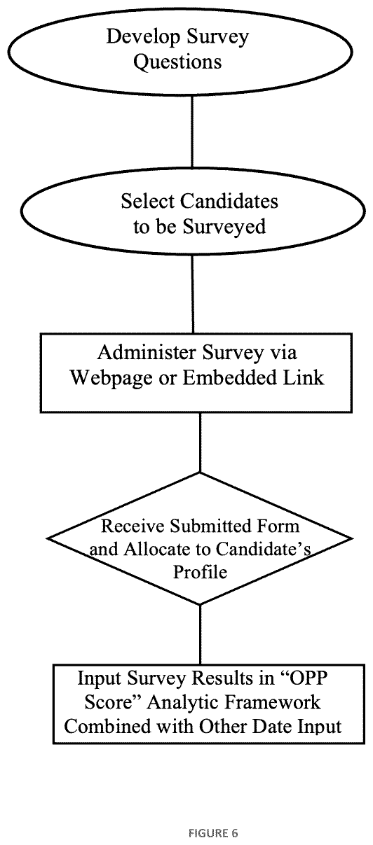

FIG. 6 displays the process of survey generation, survey candidate selection, survey transmission, receipt, and survey data analysis.

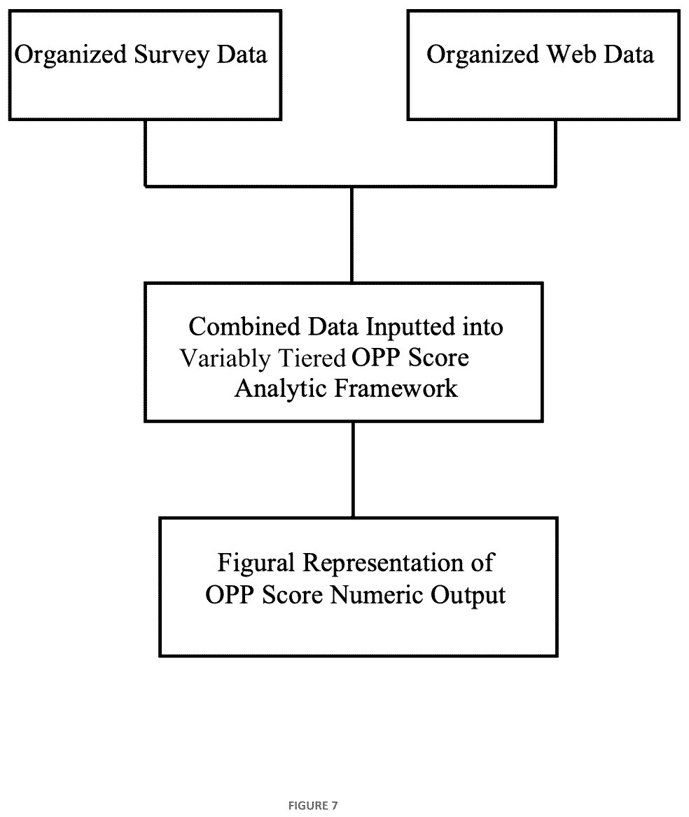

FIG. 7 is a high-level block diagram showing the combination of data types and their joint and concurrent analysis in generating the OPP score.

### DETAILED DESCRIPTION

A detailed description of preferred embodiments of the present invention will be given below with reference to the accompanying drawings. In the following description of the present invention, when it is determined that a detailed description of a related well-known function or element may make the gist of the present invention unnecessarily vague, the detailed description will be omitted.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, modules, methods, and/or operating systems described herein are for illustrative purposes and, thus, are not intended to be limited to any particular named manufacturer.

In various exemplary embodiments, aspects of the system utilize hardware such as computers, processors, communication networks, as well as an evaluation module with various subroutines and/or software “module” for facilitating one or more of the analyses described below. For ease of explanation, the hardware is not illustrated but is understood to be within the purview of one of ordinary skill and herein to be implicit.

FIG. 1 is a block and line diagram representing one iteration of the data lifecycle in the OPP Score analytic framework. The five tiers in the middle of the diagram represents one embodiment displaying an iteration of five possible tiers of evaluation, of which, in other embodiments, the number of tiers, and the subject matter of the prongs used to guide data collection, may vary according to data availability, survey type, and the subject being evaluated. Several of the steps (or modules) shown can be performed through software and developed in accordance with the illustrated/described design parameters by one of ordinary skill. These steps or modules are evident in this figure as well as in the subsequent figures.

FIG. 2 represents one embodiment of the data metrics of consideration in evaluating a candidate's performance and how that data is then analyzed and stored. The type of publicly available data collected may vary based on the subject being evaluated. Other embodiments for example, may focus on corporate governance rather than legislative history as a criterion for narrowing down target data type.

FIG. 3 is a circle and line diagram displaying possible prong categorizations for data organization. After the data organization the respective tier data is utilized in the OPP score analytic framework, and then those generated scores are utilized in the calculation of the aggregate OPP score, representing the candidate's overall performance. The number of prongs and data categorization label may vary based on the subject to be scored and the number of tiers the OPP score may contain.

FIG. 4 represents the two types of data utilized to assess a candidate after candidate selection, and how that data is jointly utilized in calculating the individual tier scores, and the aggregate score thereafter. The two types of data shown in the pictured embodiment are publicly accessible data and data collected through survey administration. Both the type of public data, and the type of survey administrated, may vary based on the subject being scored and the selected prong categorization.

FIG. 5 represents the survey collection process and method of transmission and storage. The file size of the survey to be administered may vary based on the objective of the survey administration, the type of data being collected, and the subject of the survey to be scored. The survey may be stored through a web-based application, the survey may be stored electronically, or both. The method of transmission will be through a web-based application, including but not limited to an email server, a short message service, through a social media platform, or otherwise. Survey administration may or may not require a unique access key, the survey may or may not be modifiable by the transmitting user, the survey may or not be incorporated into the score calculation.

FIG. 6 Displays a possible embodiment of the process of survey generation, survey candidate selection, survey transmission, receipt, and survey data analysis. The steps may occur in the order display, or in a variation of the displayed order. For example, the subject or candidate to be scored may be selected before the survey is generated.

FIG. 7 is high-level block diagram exemplifying one possible embodiment of the combination of data types and their joint and concurrent analysis in generating the OPP score. The number of prongs for data organization and the number of tiers to be evaluated may vary depending on the available data, type of survey administered, and the subject being scored.

As an overview, this invention relies on a scoring method consisting of five or more tiers of evaluation. Each tier of evaluation uses uniquely categorized data parameters to generate a score reflecting the performance of the official, candidate, individual, spokesperson, officer, or otherwise in the specific tier. The scores are manually or automatically generated by an analyst from aggregated data originating from two main sources: either publicly available data, including but not limited to, SEC filings, federal and state government committee hearings, sponsored and passed legislation, “dead bills,” official statements, party platforms, media statements, news media reports, and press releases; and electronically transmitted surveys.

Both types of data are collected by using a computer connected to the internet, which enables it to receive and send information to other computers via servers operated by the internet service provider. The computer may be connected to the internet via fiber optic cable, either through a cable link or a wireless connection.

The computer my additionally be attached to external devices used for external data storage, computer manipulation and control, including but not limited to storage drives, keyboards and mouses.

The computer may have data, operating systems, analysis software, automated scraping tools, and other applicable tools stored locally. The computer can be any type of computer running a variety of default operating systems such as Windows, Macintosh, or UNIX.

The first type of data for collection may be aggregated manually or using an automated web-based tool. The raw data may be stored locally or via a web-based data collection and organization software that may be searchable through a specific query language. The raw data may or not be partitioned away from the cleaned data or categorized in a specific way as shown in FIG. 2 and FIG. 4. The data stored in a web-based software is likely accessible to any user who is has been invited to access, been given an access code, an access link, or has been manually added to an approved user list as shown in FIG. 5.

The public data collection is conducted using the internet connected computer, capable of communicating with other computers. The internet access is used to access a variety of public databases, records, resources, or other webpages hosted independently or by a hosting provider. Public data may be accessed by using a subscription-based query tool such as LexisNexis or Westlaw, and non-subscription based, freely available query tools, such as search engines and other searchable databases as shown in FIG. 2.

Any reference made to “prong,” is referring to the categorization of data, which may label identically and/or correspond with tier categorization, but correspondence is not required. “Tier,” refers to the sub-scores representative of the data collected, which may be based on the Tier's associated prongs, a combination of data collected from the prongs that may correspond to another tier, or data collected corresponding to only one prong. Data under a specific prong, need not be exclusively used in the evaluation of its identically labelled or corresponding tier. Tiers are referring to the subject or candidate of the analysis' performance in a demarcated area of evaluation, where the tier label corresponds with the subject or candidate of analysis' performance of the criteria corresponding to the label. Prongs are a method of data organization that allow for specific data to more easily be parsed in tier scoring.

The raw data, collected and stored in any of the previously delineated methods, may be cleaned and categorized in accordance with the demarcated pronged data categorizations as shown in FIG. 3 The data may be cleaned and organized in accordance with the scoring tiers either manually or using an automated software that may rely on Optical Character Recognition for file or data categorization.

The cleaned data is stored either on a local drive or through a web-based sharing software for multi-user access. Some file formats for the purpose of data storage can include, but is not limited to, .xls, .txt, or .clv files or other for the respective purpose of software specific usage or the ability to manipulate the data in a variety of spreadsheet, analysis, organization, or word processing software.

The data may or may not be used concurrently in multiple tier categories for the simultaneous scoring of said tiers. The aggregated public data may or may not be partitioned from other types of data used for the scoring of that specific tier. The data may be categorized as a whole, with respect to relevance to tier classification with disregard to source of origin or collection method.

The second type of data is collected through a survey designed to allow official, candidate, individual, spokesperson, officer, or otherwise, self-reported positionality with respect to the individually assessed tiers. The survey questions include information queries that the supplement other available data for accurate analysis and scoring of each tier both individually, and the aggregate score as shown in FIG. 4. The survey questions may be manually selected or randomly assorted from a preassembled question bank tailored to elicit responses that enable objective scoring within the individual tier scoring parameters as shown in FIG. 6.

The survey questions may be store locally on a computer or in a web-based storage software. The survey questions from the question bank selected for utilization, may be transmitted to the target official, candidate, individual, spokesperson, officer, or otherwise, either through a web-based form that can by manually filled out and submitted, or through attaching an editable document where the file can be opened and edited on a locally stored word processing software as shown in FIG. 5. Web-based forms will be transmittable through a sharable link, connecting to a form submission software, through which the submitted data can be exported to either the local or web-based data storage drive. The file based survey will be transmitted through an attachable editable file including but not limited .doc, .pdf, .txt, .xls, or .clv.

Either method of survey delivery will be available to the official, candidate, individual, spokesperson, officer, or otherwise, through electronic transmission such as email where the link will be embedded into the transmitted message, or the survey-containing file will be attached to the transmittable message as shown in FIG. 5.

The survey responses originating from the web-form, or the file form of transmission will be either downloaded or exported into a drive. The survey data will be labelled and categorized with respect to the official, candidate, individual, spokesperson, officer, or otherwise who submitted it.

The survey data is then assessed in conjunction with the public data to generate the respective tier scores. Each tier, or category of assessment is independently evaluated of the other tiers. Each tier score is assessed with respect to the support of the official, candidate, individual, spokesperson, officer, or otherwise, or lack thereof, of the principles encompassed be each tier category. These tier categories may include, but are not limited to, the stance of the official, candidate, individual, spokesperson, officer, or otherwise, and commitment to personal opportunity, economic opportunity, social opportunity, educational opportunity, and national opportunity as shown in FIG. 3. Each official, candidate, individual, spokesperson, officer, or otherwise, may be assessed on each individual tier, and the aggregate score using the performance on each tier, may be calculated using the mean performance on each tier. One embodiment calculates the score using the number of tiers used in the assessment, with that number being n, each official, candidate, individual, spokesperson, officer, or otherwise, will have a total of n+1 scores, with the additive score being the aggregate mean score.

The assessment metrics for each of the tiers are based on a the support of the official, candidate, individual, spokesperson, officer, or otherwise, or involvement initiatives, that the further the overall principle of the tier, combined with the survey results that enable a self-report of the support of the official, candidates, individual, spokesperson, officer, or otherwise, commitment to the principles the tier is assessing as shown in FIGS. 2 and 5.

Each tier score is numerically derived from a point assignment placed on affirmative or negative actions for stances associated with the official, candidate, individual, spokesperson, officer, or otherwise, for the respective tier. Some embodiments may use policy decisions, legislative history, organizational support, and survey results are rated with additive positive or negative numeric values in alignment with a predetermined criteria for which actions and positions the official, candidate, individual, spokesperson, officer, or otherwise, has taken that the further the public interest category of each specific tier.

Affirmative actions, such as supporting a specific organization, legislative proposals, legislative voting record, party positions, corporate directives, or negative actions, such as lack of support for initiates that have been defined to further the positive values tied to the respective tiers may be assigned ascending numeric value for score calculation. Using this method, the higher the numeric value, the more in alignment a official, candidate, individual, spokesperson, officer, or otherwise, is with the traits and values assessed in that specific tier.

The aggregate score value is a derivative of the scores generated in the tiered categories. Each score of each tier and the aggregate score, are published and presented using a figural representation of the generated numeric value. Each tier score and the aggregate score are numeric values associated with the delineated official, candidate, individual, spokesperson, officer, or otherwise, qualities of the respective tier section. The raw score that is generated using the OPP score framework is a numeric value, but is published and presented representatively using figural icons, where the display of each figural icon is the equivalent to a nominal value of one.

Varying scoring methodologies may be used and may vary based on the available data and the subject to be scored. Data unavailability, survey variability, and subject to be scored may affect whether the score includes a variation of the number of tiers to the score.

In some embodiments, the score for the invention is generated, optionally and in part, by the completion of a survey by the individual or on behalf of an entity where transmitted survey questions are asked, and responses are recorded electronically or otherwise. Different survey versions and iterations of the survey may be employed, where the responses generate a five-tiered or other variation of a score, and where each tier is graded through a pictographic representation of a one-to-five or another type of scale, such as a three-tiered, four-tiered, six-tiered, or other variation of the scale. The survey questions may be asked and answered by the respondent(s) via a variety of methods, including but not limited to responses including: “yes” or “no”, “true” or “false”, responses with numerical answers ranging from 1 (disagree) to 5 (agree) or another type of scale, written answers, or other types of responses.

In some embodiments, the score for the invention is generated, optionally and in part, by the completion of a survey by the individual or on behalf of an entity where transmitted survey questions are asked, and responses are recorded electronically or otherwise. Different survey versions and iterations of the survey may be employed, where the responses generate a five-tiered or other variation of a score, and where each tier is graded through a pictographic representation of a one-to-five or another type of scale, such as a three-tiered, four-tiered, six-tiered or other variation of the scale. The survey questions may be asked and answered by the respondent(s) via a variety of methods, including but not limited to responses including: “yes” or “no”, “true” or “false”, responses with numerical answers ranging from 1 (disagree) to 5 (agree) or another type of scale, written answers, or other types of responses.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

### REFERENCES

[1] Daniels, S.R., “Rehabilitating the Raters: An Assessment of Interest Group Ratings of Congress,” in Congress and the Presidency, Vol. 16, No. 1, Spring 1989.
[2] Buchalter, Yehuda Ari. Systems and Methods for Determining Competitive Market Values of an Ad Impression. 7 Dec. 2021.
[3] Deane, Paul Douglas, et al. Systems and Methods for Generating Automated Evaluation Models. 15 Oct. 2019.
[4] Gun, Fanmin, et al. Computer-Implemented Method of Administering and Scoring Integrated Reasoning Question Formats. 19 Dec. 2017.
[5] Jain, Praduman, et al. Digital Health Technology Selection for Digital Clinical Trials. 13 July 2021.
[6] Maeng, Joon, et al. Customized Device Rating System Using Device Performance Information. 15 Feb. 2020.
[7] LaPasta, Douglas G., and Martha Mincer. System and Method for Evaluating Job Candidates. 27 Jan. 2015.
[8] Nielson, Katharine, et al. Systems and Methods for Calculating Text Difficulty. 18 Jul. 2018.
[9] Olsen, Dan Reed. Systems and Methods for Assessment Administration and Evaluation. 20 Jun. 2017.
[10] Pennington, John A, et al. System and Method for Scoring Constructed Responses. 25 Aug. 2020.
[11] Rajagopalan, Nikesh Anand. Conduent Business Services LLC. 28 Mar. 2017.

What is claimed is:

1. An automatic scoring system for aggregating and analyzing digital data from publicly available information of an individual to determine a competency of the individual, comprising:
a database containing aggregated public information concerning an individual; and
an evaluation module, reading the aggregated public information and generating at least one of a score and rating of the individual in respect to a predetermined topic, wherein the at least one score and rating is viewable by another individual.

2. The system of claim 1, wherein the individual is a representative of an organization or political party.

3. The system of claims 1 or 2, wherein the individual is at least one of a business candidate and public office candidate.

4. The system of claims 1 or 2, wherein the individual is at least one of a business official and a public office official.

5. The system of claims 1 or 2, wherein the database contains survey information concerning the individual.

6. The system of claim 4, wherein the survey information is obtained from a survey at least one of sent to the individual and received by the evaluation module.

7. The system of claims 1 or 2, wherein the at least one score and rating is a multi-tiered score, each tier is graded through a numeric and pictographic representation of a variably tiered score, wherein the evaluation module evaluates at least one of position consistency, legislative history, substantive policy stances and categoric public interest commitment of the individual.

8. The system of claims 1 or 2, wherein the evaluation module evaluates at least one of personal opportunity, economic opportunity, social opportunity, educational opportunity and national opportunity of the individual.

9. The system of claims 1 or 2, wherein the evaluation module further comprises:
a data cleaner module;
a categorization module;
an analysis module;
a score aggregation module; and
an individual profile uploading module.

10. The system of claim 6, wherein questions of the survey information are modifiable according to a desired metric of evaluation.

11. The system of claim 9, wherein the least one of score and rating is based on a number of tiers (n), the individual having a total of n+1 scores, wherein an additive score is an aggregate mean score.

12. The system of claim 7, further comprising an aggregate score value which is a derivative of scores generated in tiered categories.

13. A method of aggregating and analyzing digital data from publicly available information of a person or entity to determine a competency of the target person or entity, comprising:
a computerized system running an evaluation software module, performing steps comprising:
polling a database for aggregated public information concerning the person or entity;
reading the aggregated public information;
generating at least one of a score and rating of the person or entity in respect to a predetermined topic based on the read information; and
displaying the at least one score and rating to another individual.

14. The method of claim 13, wherein the person or entity is representative of a private or public organization.

15. The method of claim 13, further comprising sending a survey to the person or entity to obtain a response.

16. The method of claim 15, wherein the database contains survey information concerning the person or entity.

17. The method of claim 13, further comprising evaluating at least one of position consistency, legislative history, substantive policy stances and categoric public interest commitment of the person or entity.

18. The method of claim 13, further comprising evaluating at least one of personal opportunity, economic opportunity, social opportunity, educational opportunity and national opportunity of the person or entity.

18. The method of claim 13, wherein the at least one score and rating is a multi-tiered score, each tier, and further grading through at least one of a numeric and pictographic representation of a variably tiered score.

19. The method of claim 13, wherein the steps further comprise:
developing survey questions:
selecting the person or entity to be surveyed;
administering the survey questions via a webpage or embedded link;
receiving a survey response from the person or entity;
allocating the survey response to a profile of the person or entity; and
inputting results of the survey response into the generating step.

20. The method of claim 13, wherein the evaluation software module further:
combining survey data and organized web data;
inputting the combined data to a variably tiered score analytic evaluation module; and
outputting a figural representation of an output of the variably tiered score analytic evaluation module.
